(19) United States
(12) Patent Application Publication
(10) Pub. No.: US 2026/0333259 A1
(43) Pub. Date: Oct. 22, 2026

(54) CHANNEL CORRELATION FEEDBACK BASED ON SYNCHRONIZATION SIGNALS

(71) Applicant: Lenovo (United States) Inc., Morrisville, NC (US)

(72) Inventors: Mahdi Barzegar Khalilsarai, Berlin (DE); Hedieh Ajam, Nürnberg (DE); Seyedomid Taghizadeh Motlagh, Oberursel (DE)

(73) Assignee: Lenovo (United States) Inc., Morrisville, NC (US)

(21) Appl. No.: 19/445,409

(22) Filed: Jan. 9, 2026

(51) Int. Cl. H04W 56/00; H04W 24/10; H04W 72/1263; H04W 74/0833

(52) U.S. Cl. CPC H04W 56/0015; H04W 24/10; H04W 72/1263; H04W 74/0833

(57) ABSTRACT

Various aspects of the present disclosure relate to channel correlation feedback based on synchronization signals. A user equipment (UE) receives a set of synchronization signals (SSs) corresponding to a set of directional transmit beams. The UE computes one or more channel correlation metrics based on the set of SSs. The UE transmits a signal indicating the one or more channel correlation metrics.

### TECHNICAL FIELD

The present disclosure relates to wireless communications, and more specifically to channel correlation feedback based on synchronization signals (SSs).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The device (e.g., NE or UE), processors, and methods of the present disclosure each have several innovative aspects, no single of which is solely responsible for the desirable features disclosed herein.

A UE for wireless communication is described. The UE may be configured to, capable of, or operable to perform one or more operations as described herein. For example, the UE may be configured to, capable of, or operable to receive a set of SSs corresponding to a set of directional transmit beams, compute one or more channel correlation metrics based on the set of SSs, and transmit a signal indicating the one or more channel correlation metrics.

A processor (e.g., a standalone processor chipset, or a component of the UE) for wireless communication is described. The processor may be configured to, capable of, or operable to perform one or more operations as described herein. For example, the processor may be configured to, capable of, or operable to receive a set of SSs corresponding to a set of directional transmit beams, compute one or more channel correlation metrics based on the set of SSs, and transmit a signal indicating the one or more channel correlation metrics.

A method performed or performable by a UE for wireless communication is described. The method may include receiving a set of SSs corresponding to a set of directional transmit beams, computing one or more channel correlation metrics based on the set of SSs, and transmitting a signal indicating the one or more channel correlation metrics.

In some implementations, the UE, the processor, and the method may further be configured to, capable of, or operable to transmit a signal indicating a capability of the UE to report the one or more channel correlation metrics. In some implementations, the signal indicating a capability of the UE to report the one or more channel correlation metrics is carried in message 3 (Msg3) of a random access channel (RACH) procedure or an uplink radio resource control (RRC) message.

In some implementations, the UE, the processor, and the method may further be configured to, capable of, or operable to receive a signal that triggers the UE to report the one or more channel correlation metrics. In some implementations, the signal that triggers the UE to report the one or more channel correlation metrics is carried in message 4 (Msg4) of a RACH procedure or downlink control information (DCI).

In some implementations, the UE, the processor, and the method may further be configured to, capable of, or operable to receive a signal that schedules the UE to report the one or more channel correlation metrics. In some implementations, the signal that schedules the UE to report the one or more channel correlation metrics is carried in a system information block (SIB) or DCI. In some implementations, the signal indicating the one or more channel correlation metrics is carried in RRC-configured uplink control information (UCI).

In some implementations, In some implementations, the UE, the processor, and the method may further be configured to, capable of, or operable to receive a SIB that indicates a quantity of bits to represent the one or more channel correlation metrics and compute a quantization of the one or more channel correlation metrics based on the SIB, where the signal indicating the one or more channel correlation metrics includes the quantization of the one or more channel correlation metrics.

An NE (e.g., a base station) for wireless communication is described. The NE may be configured to, capable of, or operable to perform one or more operations as described herein. For example, the NE may be configured to, capable of, or operable to transmit a set of SSs using a set of directional transmit beams and receive a signal indicating one or more channel correlation metrics that are based on the set of SSs.

A processor (e.g., a standalone processor chipset, or a component of an NE) for wireless communication is described. The processor may be configured to, capable of, or operable to perform one or more operations as described herein. For example, the processor may be configured to, capable of, or operable to transmit a set of SSs using a set of directional transmit beams and receive a signal indicating one or more channel correlation metrics that are based on the set of SSs.

A method performed or performable by an NE (e.g., a base station) for wireless communication is described. The method may include transmitting a set of SSs using a set of directional transmit beams and receiving a signal indicating one or more channel correlation metrics that are based on the set of SSs.

In some implementations, the NE, the processor, and the method may further be configured to, capable of, or operable to receive a signal indicating a capability of a UE to report the one or more channel correlation metrics. In some implementations, the signal indicating a capability of the UE to report the one or more channel correlation metrics is carried in Msg3 of a RACH procedure or an uplink RRC message.

In some implementations, the NE, the processor, and the method may further be configured to, capable of, or operable to transmit a signal that triggers a UE to report the one or more channel correlation metrics. In some implementations, the signal that triggers the UE to report the one or more channel correlation metrics is carried in Msg4 of a RACH procedure or DCI.

In some implementations, the NE, the processor, and the method may further be configured to, capable of, or operable to transmit a signal that schedules a UE to report the one or more channel correlation metrics. In some implementations, the signal that schedules the UE to report the one or more channel correlation metrics is carried in a SIB or DCI. In some implementations, the signal indicating the one or more channel correlation metrics is carried in RRC-configured UCI.

In some implementations, the NE, the processor, and the method may further be configured to, capable of, or operable to transmit a SIB that indicates a quantity of bits to represent the one or more channel correlation metrics, where the signal indicating the one or more channel correlation metrics includes a quantization of the one or more channel correlation metrics that is based on the SIB.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIG. 3 illustrates an example of a process flow in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates an example of a flowchart of a method performed by a UE in accordance with aspects of the present disclosure.

FIG. 8 illustrates an example of a flowchart of a method performed by an NE in accordance with aspects of the present disclosure.

### DETAILED DESCRIPTION

An NE of a wireless communications system may broadcast SSBs such that a UE of the wireless communications system may recognize the NE and synchronize to the NE. In some examples, to increase coverage of SSB transmission, the NE may perform SSB beam sweeping. During SSB beam sweeping, the NE may transmit a set of SSBs using a set of directional transmit beams. Each SSB may include SSs (e.g., a primary SS (PSS) and a secondary SS (SSS)) whose sequences are known to the UE. As such, these SSs may act as reference signals from which the UE may obtain channel measurements. However, there is no framework in place that enables the UE to obtain such channel measurements from the SSs and report such channel measurements to the NE. Having such framework in place would improve channel estimation at the NE, among other benefits.

The techniques described herein enable the UE to compute channel correlation metrics using SSs received from the NE and report the channel correlation metrics to the NE. In some examples, the UE may receive, from the NE, a set of SSs that correspond to a set of directional transmit beams. Upon receiving the set of SSs, the UE may compute one or more channel correlation metrics based on the SSs (or measurements obtained from the SSs). In some examples, the one or more channel correlation metrics may include one or more covariance matrices. In such case, the UE may compress the one or more channel correlation metrics. For example, the UE may quantize the one or more channel correlation metrics according to a scalar quantizer. Upon computing the one or more channel correlation metrics, the UE may transmit, to the NE, a report that includes an indication of the one or more channel correlation metrics. Using the report, the NE may estimate a communication channel between the UE and the NE which the NE may use to improve future communications with the UE.

It should be understood that various terms may be used interchangeably with “communicating,” such as “signaling,” “transmitting,” “receiving,” “outputting,” “forwarding,” “relaying,” “retrieving,” “obtaining,” and so forth.

By performing the techniques described, the wireless communications system provides multiple benefits. For example, because obtaining the one or more channel correlation metrics is based on SSs, the one or more channel correlation metrics may be acquired during initial access and used as soon as the UE is in a connected mode enabling high-quality channel estimates earlier in the communication procedure when compared to other methods. Additionally, the techniques described may improve uplink channel estimation with uplink sounding reference signals (SRSs) under uplink-downlink channel reciprocity. Additionally, the techniques described may suppress downlink inter-user or inter-layer interference via statistical precoding. For example, the one or more channel correlation metrics may enable the NE to choose a precoder that does not transmit to unwanted UEs.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

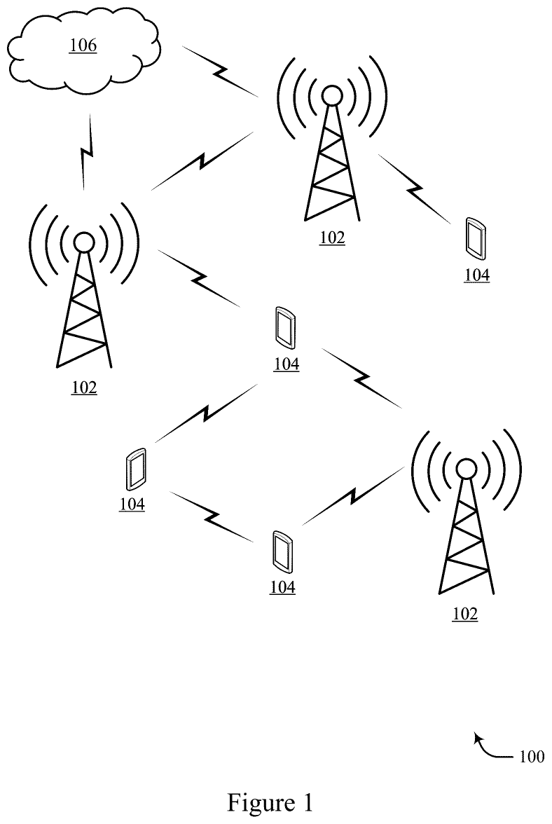

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHz), FR4a or FR4-1 (52.6 GHZ-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support SSs. For example, the NE 102 may periodically transmit a set of SSs carried in a synchronization signal block (SSB) which may enable the UE 104 to recognize the NE 102 and synchronize to the NE 102. A singular SSB may span 4 OFDM symbols in a time domain and a maximum of 240 subcarriers in a frequency domain. A first OFDM symbol of the SSB may include a PSS and a third OFDM symbol of the SSB may include an SSS. The PSS and the SSS may span 127 subcarriers in the frequency domain. A second OFDM, the third OFDM symbol, and a fourth OFDM symbol of the SSB may include a physical broadcast channel (PBCH) which may span 240 subcarriers.

The NE 102 may transmit SSBs on a synchronization raster. The synchronization raster may include a limited number of frequency domain locations from which the UE 104 searches for an SSB. Further, the NE 102 may transmit SSBs with a period between 5 milliseconds (ms) and 160 ms. At least one SSB may occur once every 20 ms. If the UE 104 is unable to find the SSB for synchronization within 20 ms, the UE 104 may modify frequency in the synchronization raster.

There may be a limited quantity of possible SSB numerologies for each frequency band which allows for efficient detection of the SSB for the UE 104. The SSs and PBCH of the SSB may support a 15 and 30 kHz subcarrier spacing in FR1, a 120 and 240 kHz subcarrier spacing in FR2-1 and FR2-NTN, and a 120, 480, and 960 kHz subcarrier spacing in FR2-2. In some examples, all SSs and PBCH of a cell may have a same subcarrier spacing. A quantity of subcarriers and bandwidth used by an SSB may take on different values. For example, in FR1, the bandwidth may be either 3.6 or 7.2 MHz with a location in the frequency domain given by the synchronization raster.

Using the PSS and the SSS, the UE 104 may determine a physical cell identity (PCI) among 1008 unique PCI values which is given by Equation 1, where

$${N}_{ID}^{( 1 )} ∈ \{ 0 , 1 , … , 335 \} and {N}_{ID}^{( 1 )} = ∈ \{ 0 , 1 , 2 \} . \qquad ( 1 )$$

$${N}_{ID}^{c e l l} = 3 {N}_{ID}^{( 1 )} + {N}_{ID}^{( 2 )}$$

The UE 104 may detect the PSS to acquire a symbol boundary and a course frequency synchronization which thereby eliminating frequency deviation between the UE 104 and the NE 102. There may be 3 different PSSs denoted by dₚₛₛ. The 3 different PSSs are cyclic shifts of a BPSK M-sequence with length 127 in the frequency domain. The NE 102 selects the PSS based on the PCI and transmits the PSS to the UE 104. The f-th element of the M-sequence may be given by Equations 2, 3, and 4, where

$$m = ( n + 43 {N}_{ID}^{( 2 )} ) mod 127 and 0 \leq f \leq 127.$$

$${d}_{p s s} [ f ] = 1 - 2 x [ m ] \qquad ( 2 )$$

$$x [ f + 7 ] = x [ f + 4 ] ⊕ x [ f ] \qquad ( 3 )$$

$$[ x ( 6 ) x ( 5 ) x ( 4 ) x ( 3 ) x ( 2 ) x ( 1 ) x ( 0 ) ] = [ 1110110 ] \qquad ( 4 )$$

The UE 104 may detect the SSS using the PSS. The SSS may include a Gold sequence of length 127 and two M-sequences defined by polynomials, x[f] and y[f], as shown in Equation 5.

$$y [ f + 7 ] = y [ f + 1 ] ⊕ y [ f ] \qquad ( 5 )$$

The SSS sequence may be given by Equation 6, where

$${m}_{1} = 15 [ \frac{{N}_{ID}^{( 1 )}}{112} ] + 5 {N}_{ID}^{( 2 )} and {m}_{2} = {N}_{ID}^{( 1 )} mod 112. \qquad ( 6 )$$

$${d}_{s s s} [ f ] = [ 1 - 2 x [ ( f + {m}_{1} ) mod 127 ] ] [ 1 - 2 y [ ( f + {m}_{2} ) mod 127 ] ]$$

336 different SSS sequences and 3 different PSS sequences may result in 1008 unique PCIs. The M-sequence is uncorrelated with its shifted version and has autocorrelation and low cross-correlation between two different cyclic shifts of an M-sequence as shown in Equation 7, where F_{g}=127 (number of SSS and PSS subcarriers).

$${R}_{dd} [ k ] = {\sum }_{f = 0}^{{F}_{s s s} - 1} {d}_{g} [ f ] {d}_{g}^{*} [ f - k ] = \{ \begin{matrix}1 , & k = 0 , \\ \frac{- 1}{{F}_{g}} , & k \neq 0 ,\end{matrix} g ∈ \{ S SS , PSS \} \qquad ( 7 )$$

The UE 104 may compute a correlation between the received signal and each possible PSS sequence using this property of the M-sequence and determine

$${N}_{ID}^{( 2 )} ∈ \{ 0 , 1 , 2 \} .$$

This reduces the PCI search to 336 values. Using the PSS timing, the UE 104 may extract the SSS. As a result of generating the 336 SSS sequences and computing the correlations in Equation 7, the UE 104 may determine a highest correlation value and select

$${N}_{ID}^{( 1 )}$$

and thus, determine the PCI (e.g., using Equation 1).

The wireless communications system 100 may further support beam sweeping. In some examples, the NE 102 may transmit multiple SSBs using multiple directional beams. For example, the NE 102 may transmit a first SSB corresponding to a first SSB index using a first directional transmit beam and a second SSB corresponding to a second SSB index using a second directional transmit beam. Transmission of the multiple SSBs may be known as an SS burst set which may employ time-multiplexed directional transmit beams to increase coverage of SSB transmission using beam sweeping. Each SS burst set may be limited to 5 ms and have a minimum periodicity and a maximum periodicity of 5 ms and 160 ms, respectively. Further, a quantity of SSBs included in the SS burst set may be 8 SSBs in FR1 and 64 SSBs in FR2. In other words, a maximum of 8 directional transmit beams in FR1 and 64 directional transmit beams in FR2 may be used for beam sweeping of SSBs.

An SSB received by the UE 104 may correspond to a set of frequency subcarriers (e.g., f₁, . . . , f_{N}_{_{sc}}) and a quantity of directional transmit beams (e.g., b₁, . . . , b_{N}_{_{b}}) which each correspond to a different time. A received SSB signal may be represented by Equation 8, where b is a directional transmit beam, k is a frequency subcarrier and OFDM symbol indices, t is a time index where an SS is transmitted, H[k,t] is a Nᵣₓ (receive antenna ports)×Nₜₓ (transmit antenna ports) matrix of downlink channel coefficients on subcarrier k, f_{b} is a Nₜₓ×1 vector corresponding to beamforming coefficients of beam b, s[b, k, t] is a complex-valued symbol that is known to the UE 104, and u is a Nₜₓ×1 receive beam of the UE, and z[b, k, l] is additive white Gaussian noise.

$$y [ b , k , t ] = {u}^{H} H [ k , t ] {f}_{b} s [ b , k , t ] + z [ b , k , t ] \qquad ( 8 )$$

Not only do SSBs enable the UE 104 to obtain the PCI, SSBs may also enable the UE 104 to obtain some channel attributes (e.g., reference signal receive power (RSRP) values). SSBs include sequences known to the UE 104 (e.g., the PSS and the SSS). Thus, these sequences may act as reference signals from which the UE 104 may acquire channel measurements. The aspects as described herein relate to UEs 104 using downlink SSs (e.g., PSSs and SSSs) to estimate and feedback channel correlation metrics to the network which may improve channel estimation accuracy at the network resulting in improved precoding and scheduling.

According to implementations, one or more of the NEs 102 and the UEs 104 are operable to implement various aspects of the techniques described with reference to the present disclosure. For example, a UE 104 receives a set of SSs corresponding to a set of directional transmit beams, computes one or more channel correlation metrics based on the set of SSs, and transmits a signal indicating the one or more channel correlation metrics. An NE 102 (e.g., a base station, gNB) transmits a set of SSs using a set of directional transmit beams and receives a signal indicating one or more channel correlation metrics that are based on the set of SSs.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

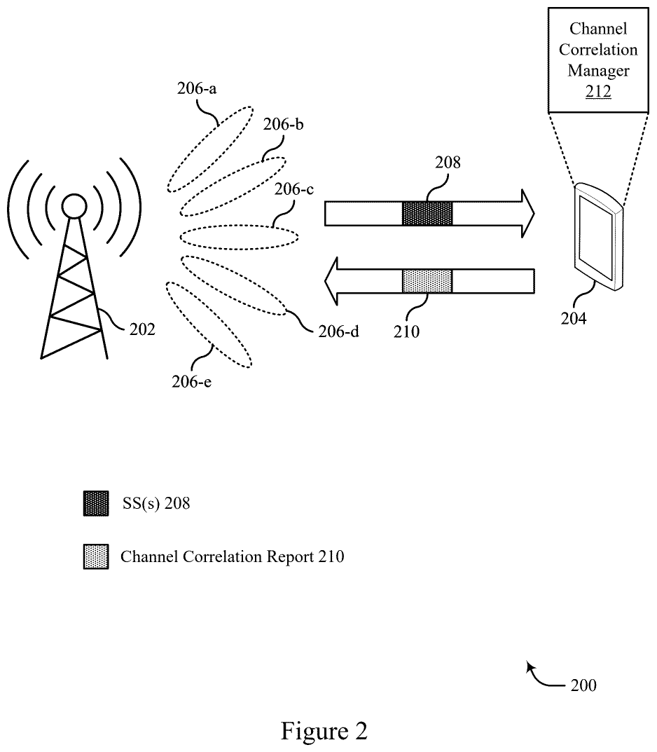

FIG. 2 illustrates an example of a wireless communications system 200 in accordance with aspects of the present disclosure. In some examples, the wireless communications system 200 may implement aspects of the wireless communications system 100. For example, the wireless communications system 200 may include an NE 202 and a UE 204 which may be examples of the NE 102 and the UE 104 as described with reference to FIG. 1, respectively. In some examples, the NE 202 may be equipped with Nₜₓ transmit antenna ports and the UE 204 may be equipped with Nᵣₓ receive antenna ports.

Using other techniques, the UE 204 may transmit channel state information (CSI) to the NE 202. The CSI may include features of a wireless communication channel between the UE 204 and the NE 202. Availability of the CSI may enable precoding and beamforming at the NE 202 and coherent combining at the UE 204. Channel coefficients included in the CSI are defined over space, time, and frequency. Knowledge of correlations between the channel coefficients may help improve channel estimation accuracy from reference signals in either uplink or downlink. The methods described herein relate to the UE 204 using SSs (e.g., PSS and SSS of an SSB) to estimate and feedback channel correlation metrics (or correlations between channel coefficients) to the NE 202 which the NE 202 may then use to improve channel estimation based on received uplink reference signals (e.g., sounding reference signals (SRSs)).

As shown in FIG. 2, the NE 202 may transmit a set of SSs 208 to the UE 204 using a set of directional transmit beams 206 (e.g., one or more of a directional transmit beam 206-a, a directional transmit beam 206-b, a directional transmit beam 206-c, a directional transmit beam 206-d, and a directional transmit beam 206-e). In some examples, the SSs 208 may be carried in one or more SSBs. For example, the NE 202 may transmit a first SSB using the directional transmit beam 206-a that includes a respective PSS and SSS and further transmit a second SSB using the directional transmit beam 206-b that includes a respective PSS and SSS. In some examples, the NE 202 may support SSB beam sweeping. That is, the NE 202 may transmit multiple time-multiplexed SSBs or an SSB burst set using the set of directional transmit beams 206.

Upon receiving the SSs 208 (e.g., carried in the one or more SSBs), a channel correlation manager 212 of the UE 204 may compute one or more channel correlation metrics of SS measurements over the set of directional transmit beams using Equation 9, where T is a total quantity of symbols, K is a total quantity of subcarriers,

$${\hat{Σ}}_{sp}^{ssb} is a {N}_{b} \times {N}_{b}$$

matrix mat represents a correlation of measurements of pairs of beams, and

$${\hat{Σ}}_{sp}^{ssb} [ b , {b}^{′} ]$$

denotes an element (b, b′) in the N_{b}×N_{b} matrix.

$${\hat{Σ}}_{sp}^{ssb} [ b , {b}^{′} ]$$

may represent a sample covariance of measurements across directional transmit beams.

$${\hat{Σ}}_{sp}^{ssb} [ b , {b}^{′} ] = \frac{1}{TK} {\sum }_{k , t} {y [ b , k , t ]}^{*} y [ {b}^{′} , k , t ] \qquad ( 9 )$$

The channel correlation manager 212 of the UE 204 may rearrange Equation 8 to obtain measurements across all directional transmit beams 206 as shown in Equation 10, where y[k, t] is a row vector including elements y[b, k, t]^{H} for b=1, . . . , N_{b}, F_{b} is a matrix of dimension N_{b}×Nₜₓ, h_{k,t}=u^{H} H[k, t], and z[k, t] includes noise elements for all b. Each row of the matrix of dimension N_{b}×Nₜₓ is given by

$${f}_{b}^{H}$$

for b=1, . . . N_{b}. It should be understood that the baseband signal model of the received SSB as shown in Equation 8 is only assumed for symbols of the SSB constituting the PSS and the SSS. Thus, it is safely assumed that the symbol s[b, k, t] to be equal to a constant transmit power square root s[b, k, t]=\sqrt{P} for all indices.

$${y [ k , t ]}^{H} = \sqrt{P} {F}_{b} {h}_{k , t}^{H} + z [ k , t ] \qquad ( 10 )$$

Considering Equations 9 and 10, the channel correlation manager 212 of the UE 204 may obtain an Equation 11 for

$${\hat{Σ}}_{sp}^{ssb} , where {\hat{Σ}}_{sp} = \frac{1}{TK} {\sum }_{k} {h}_{k , t}^{H} {h}_{k , t}$$

is a spatial sample covariance of the true channel.

$${\hat{Σ}}_{sp}^{ssb} = {PF}_{b} {\hat{Σ}}_{sp} {F}_{b}^{H} + noise \qquad ( 11 )$$

The channel correlation manager 212 of the UE 204 may remove the noise, scale P, and compute a covariance matrix

$$X = {F}_{b} {\hat{Σ}}_{sp} {F}_{b}^{H}$$

of dimension N_{b}×N_{b}. In some examples, the one or more channel correlation metrics may include the covariance matrix X.

Alternatively, or additionally, upon receiving the SSs 208 (e.g., carried in the one or more SSBs), the channel correlation manager 212 of the UE 204 may compute one or more channel correlation metrics of SS measurements separately per set of consecutive subcarriers, over PRBs, or over subbands. In this scenario, the channel correlation manager 212 may compute the sample covariance by averaging over a quantity of subcarriers in each subset of subcarriers. Using this technique may allow the NE 202 to obtain more granular information of covariance in the frequency domain.

Upon computing the one or more channel correlation metrics, the UE 204 may transmit a channel correlation report 210 that includes an indication of the one or more channel correlation metrics.

In some examples, prior to generating the channel correlation report 210, the channel correlation manager 212 of the UE 204 may compress the one or more channel metrics using one or more techniques. As described above, the one or more channel metrics may include covariance matrix X of dimension N_{b}×N_{b} which results in a number of degrees of freedom or free parameters given by Equation 12.

$${N}_{coefficients} = \frac{{N}_{b} ( {N}_{b} + 1 )}{2} \qquad ( 12 )$$

Using one technique, the channel correlation manager 212 of the UE 204 may quantize N_{coefficients} according to a scaler quantizer. For example, the UE 204 may report B*N_{coefficients} bits to represent a single covariance for an entire bandwidth, where B represents a quantity of bits used by the scalar quantizer to quantize a single complex number. As another example, the UE 204 may report BN_{subsets}N_{coefficents} bits to represent N_{subsets} covariances, each for one subset of subcarriers (e.g., a subband).

For each complex coefficient constituting the covariance or set of covariances, the channel correlation manager 212 may use B₁ bits to represent amplitude and B₂ to represent phase. Thus, B₁+B₂=B, where B₁ and B₂ may be configured by the NE 202. In one example, the NE 202 may transmit SSBs using 8 directional transmit beams 206 or N_{b}=8. In such example, the UE 204 may compute 36 complex coefficients (e.g., using Equation 12) and if the UE 204 quantizes each coefficient with B=4 bits, the UE 204 may report 144 bits. If the UE 204 reports one covariance for each of N_{subsets}=5, a total quantity of bits reported to the NE 202 may include 720 bits.

In some examples, the UE 204 may report a scalar value (e.g., real or imaginary scalar value) of the complex coefficient associated with a covariance matrix based on the scalar value meeting (e.g., exceeding) a threshold. Additionally, or alternatively, if a diagonal element of the covariance matrix is below a threshold, the UE 204 may not report the element.

In some examples, a truncated version of the covariance matrix is reported. For example, the UE 204 may report covariance over a subset of all available directional transmit beams 206. In such example, the channel correlation report 210 may include indices of the subset of directional transmit beams 206 to be reported and a covariance matrix of the subset of directional transmit beams 206 are quantized and included in the channel correlation report 210.

In some examples, the channel correlation manager 212 of the UE 204 may normalize the covariance according to an apriori known normalization rule. The normalization rule may specify for the channel correlation manager 212 to normalize the covariance such that a largest diagonal element is equal to 1. Alternatively, the normalization rule may specify for the channel correlation manager 212 to scale down the covariance such that a summation of all the diagonal elements (e.g., a trace operation over the said matrix) is equal to 1. In some examples, the channel correlation report 210 may include a scale variable (e.g., a trace of the covariance or the scalar value over which the scalar values are normalized) together with the normalized covariance.

In some examples, the channel correlation manager 212 of the UE 204 may quantize different elements of the covariance (e.g., diagonal values, off-diagonal values, normalized values, or individual normalized values) according to different quantization rules. Thus, a different quantity of bits may represent different elements of the covariance. In another example, the channel correlation manager 212 may quantize and report an off-diagonal value of the covariance (e.g., γᵢⱼ as the element (i,j) of the covariance matrix) relative to diagonal values of the covariance (e.g., γᵢⱼ=\sqrt{γᵢᵢγᵢⱼ}×γ̅ᵢ̅ⱼ̅) such that the value of Yu is quantized (e.g., alongside the diagonal elements) and reported.

The NE 202 may receive the channel correlation report 210 and estimate channel correlation metrics for the communication channel based on the channel correlation report 210. Using one technique, the NE 202 may estimate the correlation metrics for the communication channel by searching for a positive semi-definite matrix (PSD) that best matches the covariance. For example, the NE 202 may utilize Equation 13. Using another technique, the NE 202 may consider a sparse multi-path channel model, parameterize it, and estimate the covariance by enforcing a sparsity measure on the underlying channel.

$${minimize}_{Σ} {‖ X - {F}_{b} Σ {F}_{b}^{H} ‖}_{F} subject to : Σ is PSD \qquad ( 13 )$$

In some examples, the UE 204 or the NE 202 may assume one or more conditions or metrics during channel correlation metric estimation. For example, the NE 202 or the UE 204 may assume that the applied spatial filter, u, may be the same during channel correlation metric estimation over the set of directional transmit beams 206 or the set of SSB bursts. Alternatively, the NE 202 or the UE 204 may assume the best spatial filter at each SSB reception. In some examples, a receive filter used by the UE 204 for reception of SSBs may be different than a receive filter used by the UE 204 for reception of physical data or control channel signals. The NE 202 may use knowledge of the receive filter to further refine the communication channel, H. Using one technique, the NE 202 or the UE 204 may assume the receive filter is the best receive filter at the UE 204 for reception of the strongest directional transmit beam 206 which is selected by the UE 204. In such example, the receive filter corresponds to the reception of an SSB associated with a PRACH transmission occasion. Using another technique, the best directional transmit beam 206 is inferred by the NE 202 upon reception of the channel correlation report 210. Using yet another technique, the UE 204 may autonomously select the receive filter based on local knowledge of antenna placement, radiation pattern, or physical properties of the UE 204 such as to resemble an omnidirectional receive pattern from a combined antenna anergy reception perspective. Using such technique, the NE 202 may assume equal weighting of multi-path components (e.g., for sparce path parameter recovery based on the channel correlation report 210).

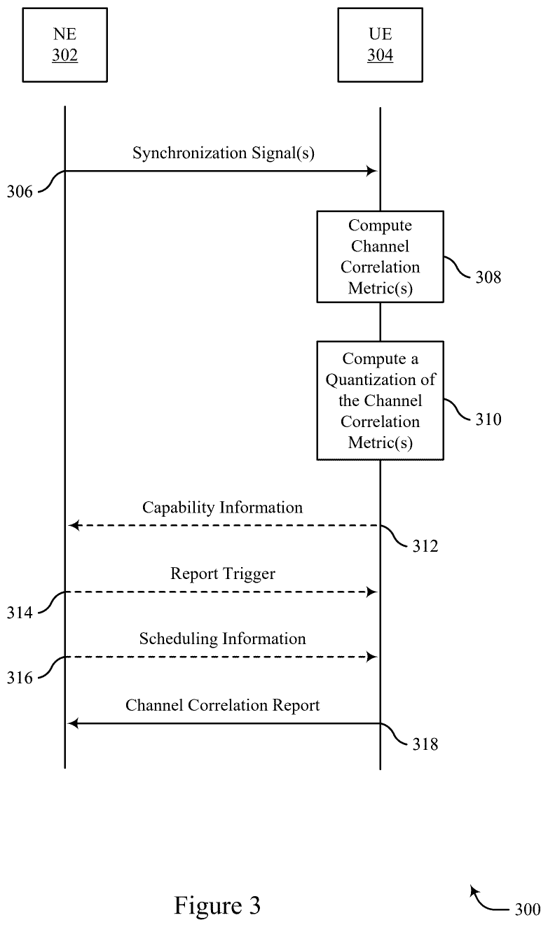

FIG. 3 illustrates an example of a process flow 300 in accordance with aspects of the present disclosure. In some examples, the process flow 300 may implement, or be implemented by, aspects of the wireless communications system 100 or the wireless communications system 200. For example, the process flow 300 may be implemented by an NE 302 which may be an example of the NE 102 or the NE 202 as described with reference to FIGS. 1 and 2. Further, the process flow 300 may be implemented by a UE 304 which may be an example of the UE 104 or the UE 204 as described with reference to FIGS. 1 and 2.

At 306, the NE 302 may transmit a set of SSs to the UE 304 using a set of directional transmit beams.

At 308, the UE 304 may compute one or more channel correlation metrics based on the set of SSs. In some examples, the UE 304 may perform measurements on the SSs for computation of the one or more channel correlation metrics while the UE 304 is in an idle/inactive mode and may continue SS measurements while in a connected mode.

At 310, the UE 304 may compute a quantization of the one or more channel correlation metrics. In some examples, the UE 304 may receive a SIB (e.g., SIB1 or SIB2) from the NE 302 that indicates a quantity of bits (e.g., B₁ or B₂ or B) to represent the one or more channel correlation metrics and the UE 304 may utilize the SIB, or more specifically the quantity of bits, to quantize the one or more channel correlation metrics.

At 312, the UE 304 may transmit, to the NE 302, a signal indicating a capability of the UE to report the one or more channel correlation metrics (e.g., capability information). In some examples, the signal indicating a capability of the UE to report the one or more channel correlation metrics may be carried in Msg3 of a RACH procedure (e.g., a 4-step RACH procedure) or an uplink RRC message (e.g., while the UE 304 is in the connected mode). In some examples, Msg3 includes an RRCConnectionRequest which may include a UE's capability for one or more of early SRS triggering, CSI triggering, CSI-RS triggering, or channel correlation metrics report triggering.

At 314, the UE 304 may receive, from the NE 302, a signal that triggers the UE 304 to report the one or more channel correlation metrics (e.g., a report trigger). In some examples, the signal that triggers the UE 304 to report the one or more channel correlation metrics may be carried in Msg4 of the RACH procedure or DCI.

At 316, the UE 304 may receive, from the NE 302, a signal that schedules the UE 304 to report the one or more channel correlation metrics (e.g., scheduling information). In some examples, the signal that scheduled the UE 304 to report the one or more channel correlation metrics may be carried in SIB or DCI. The scheduling information may include an indication of resources (e.g., time-frequency resources) over which a channel correlation report is sent.

At 318, the UE 304 may transmit a signal indicating the one or more channel correlation metrics (e.g., the channel correlation report). In some examples, the channel correlation report may be carried in RRC-configured UCI. The UE 304 may send the RRC-configured UCI on either an uplink control channel (e.g., PUCCH) or an uplink data channel (e.g., PUSCH). Further, the UE 304 may transmit the channel correlation report using the resources indicated in the scheduling information and in response to receiving the report trigger. In some examples, the channel correlation report may include the quantization of the one or more channel correlation metrics.

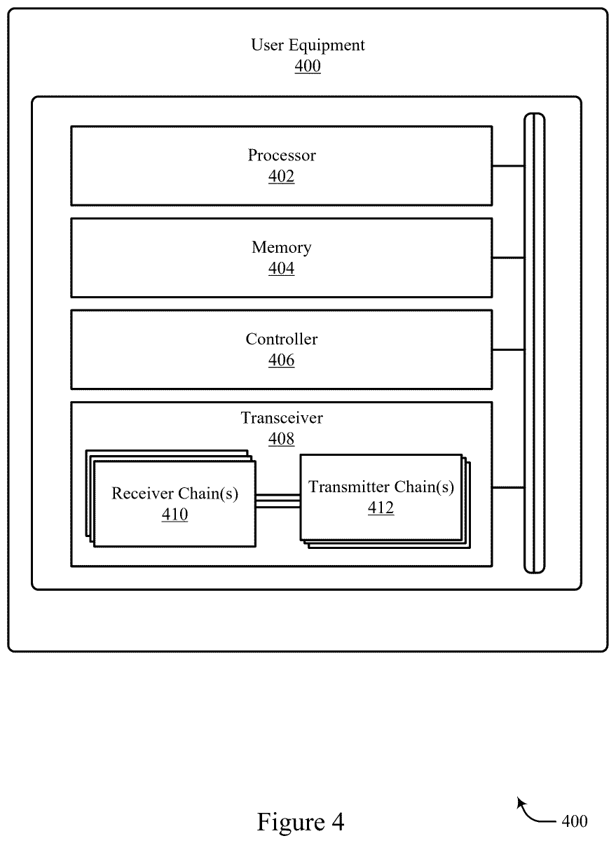

FIG. 4 illustrates an example of a UE 400 in accordance with aspects of the present disclosure. In some examples, the UE 400 may be an example of a UE as described with reference to FIGS. 1 through 3. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving a set of SSs corresponding to a set of directional transmit beams, computing one or more channel correlation metrics based on the set of SSs, and transmitting a signal indicating the one or more channel correlation metrics.

Additionally, or alternatively, the UE 400 may support at least one memory (e.g., the memory 404) and at least one processor (e.g., the processor 402) coupled with the at least one memory and configured to cause the UE to receive a set of SSs corresponding to a set of directional transmit beams, compute one or more channel correlation metrics based on the set of SSs, and transmit a signal indicating the one or more channel correlation metrics.

Additionally, the UE 400 may be configured to support any one or combination of the at least one processor configured to cause the UE 400 to transmit a signal indicating a capability of the UE to report the one or more channel correlation metrics. Additionally, the UE 400 may be configured to support any one or combination of the at least one processor configured to cause the UE 400 to receive a signal that triggers the UE to report the one or more channel correlation metrics. Additionally, the UE 400 may be configured to support any one or combination of the at least one processor configured to cause the UE 400 to receive a signal that schedules the UE to report the one or more channel correlation metrics.

Additionally, the UE 400 may be configured to support any one or combination of the at least one processor configured to cause the UE 400 to receive a SIB that indicates a quantity of bits to represent the one or more channel correlation metrics and compute a quantization of the one or more channel correlation metrics based on the SIB, where the signal indicating the one or more channel correlation metrics includes the quantization of the one or more channel correlation metrics.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

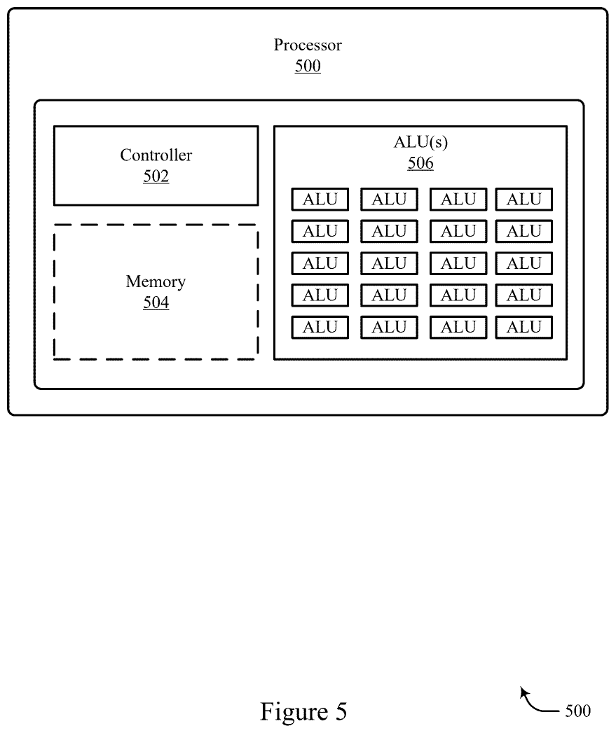

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to receive a set of SSs corresponding to a set of directional transmit beams, compute one or more channel correlation metrics based on the set of SSs, and transmit a signal indicating the one or more channel correlation metrics.

Additionally, the processor 500 may be configured to or operable to support any one or combination of transmitting a signal indicating a capability of the UE to report the one or more channel correlation metrics. Additionally, the processor 500 may be configured to or operable to support any one or combination of receiving a signal that triggers the UE to report the one or more channel correlation metrics. Additionally, the processor 500 may be configured to or operable to support any one or combination of receiving a signal that schedules the UE to report the one or more channel correlation metrics.

Additionally, the processor 500 may be configured to or operable to support any one or combination of receiving a SIB that indicates a quantity of bits to represent the one or more channel correlation metrics and computing a quantization of the one or more channel correlation metrics based on the SIB, where the signal indicating the one or more channel correlation metrics includes the quantization of the one or more channel correlation metrics.

Moreover, the processor 500 may be configured to or operable to support at least one controller (e.g., the controller 502) coupled with at least one memory (e.g., the memory 504) and configured to cause the processor to transmit a set of SSs using a set of directional transmit beams and receive a signal indicating one or more channel correlation metrics that are based on the set of SSs.

Additionally, the processor 500 may be configured to or operable to support any one or combination of receiving a signal indicating a capability of a UE to report the one or more channel correlation metrics. Additionally, the processor 500 may be configured to or operable to support any one or combination of transmitting a signal that triggers a UE to report the one or more channel correlation metrics. Additionally, the processor 500 may be configured to or operable to support any one or combination of transmitting a signal that schedules a UE to report the one or more channel correlation metrics.

Additionally, the processor 500 may be configured to or operable to support any one or combination of transmitting a SIB that indicates a quantity of bits to represent the one or more channel correlation metrics, where the signal indicating the one or more channel correlation metrics includes a quantization of the one or more channel correlation metrics that is based on the SIB.

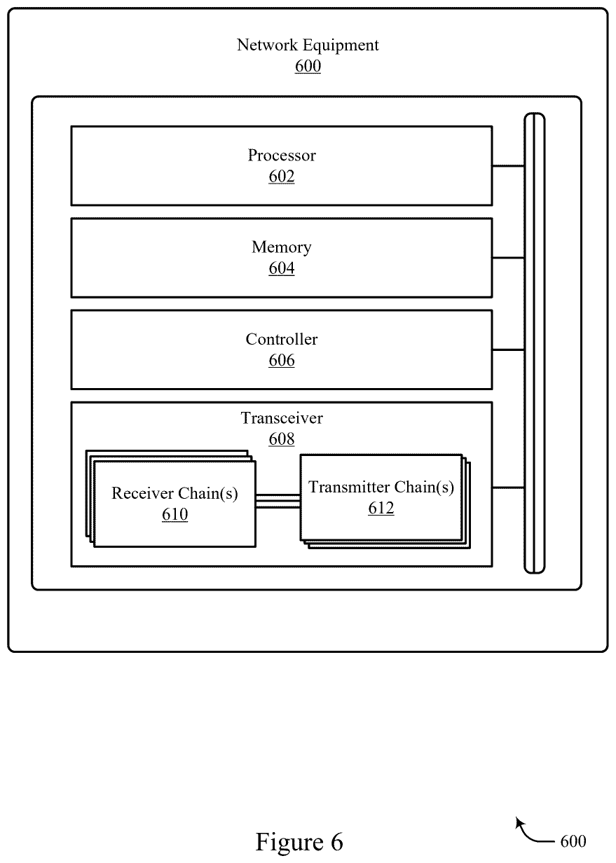

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for transmitting a set of SSs using a set of directional transmit beams and receiving a signal indicating one or more channel correlation metrics that are based on the set of SSs.

Additionally, or alternatively, the NE 600 may support at least one memory (e.g., the memory 604) and at least one processor (e.g., the processor 602) coupled with the at least one memory and configured to cause the NE to transmit a set of SSs using a set of directional transmit beams and receive a signal indicating one or more channel correlation metrics that are based on the set of SSs.

Additionally, the NE 600 may be configured to support any one or combination of the at least one processor configured to cause the NE 600 to receive a signal indicating a capability of a UE to report the one or more channel correlation metrics. Additionally, the NE 600 may be configured to support any one or combination of the at least one processor configured to cause the NE 600 to transmit a signal that triggers a UE to report the one or more channel correlation metrics. Additionally, the NE 600 may be configured to support any one or combination of the at least one processor configured to cause the NE 600 to transmit a signal that schedules a UE to report the one or more channel correlation metrics.

Additionally, the NE 600 may be configured to support any one or combination of the at least one processor configured to cause the NE 600 to transmit a SIB that indicates a quantity of bits to represent the one or more channel correlation metrics, where the signal indicating the one or more channel correlation metrics includes a quantization of the one or more channel correlation metrics that is based on the SIB.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

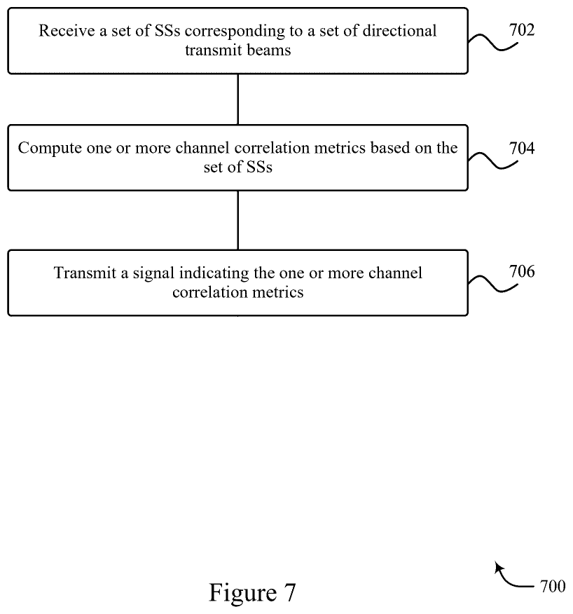

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving a set of SSs corresponding to a set of directional transmit beams. The operations of 702 may be performed in accordance with examples as described herein. In some implementations, aspects of the operations of 702 may be performed by the UE 400 as described with reference to FIG. 4.

At 704, the method may include computing one or more channel correlation metrics based on the set of SSs. The operations of 704 may be performed in accordance with examples as described herein. In some implementations, aspects of the operations of 704 may be performed by the UE 400 as described with reference to FIG. 4.

At 706, the method may include transmitting a signal indicating the one or more channel correlation metrics. The operations of 706 may be performed in accordance with examples as described herein. In some implementations, aspects of the operations of 706 may be performed the UE 400 as described with reference to FIG. 4.

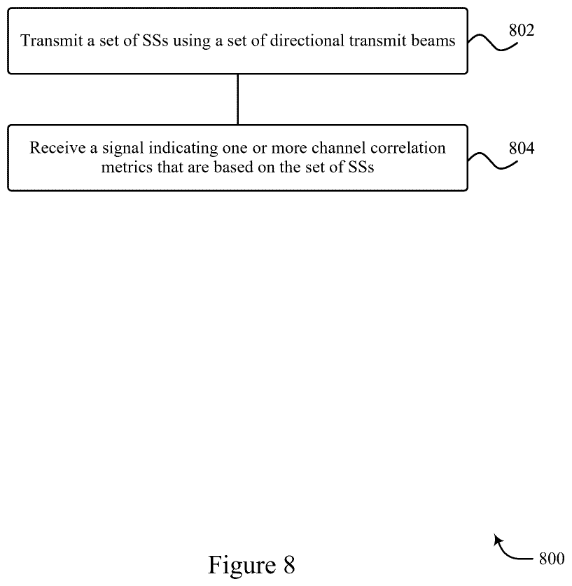

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include transmitting a set of SSs using a set of directional transmit beams. The operations of 802 may be performed in accordance with examples as described herein. In some implementations, aspects of the operations of 802 may be performed by the NE 600 as described with reference to FIG. 6.

At 804, the method may include receiving a signal indicating one or more channel correlation metrics that are based on the set of SSs. The operations of 804 may be performed in accordance with examples as described herein. In some implementations, aspects of the operations of 804 may be performed by the NE 600 as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a set of synchronization signals corresponding to a set of directional transmit beams;
compute one or more channel correlation metrics based at least in part on the set of synchronization signals; and
transmit a signal indicating the one or more channel correlation metrics.

2. The UE of claim 1, wherein the at least one processor is further operable to cause the UE to:
transmit a signal indicating a capability of the UE to report the one or more channel correlation metrics.

3. The UE of claim 2, wherein the signal indicating a capability of the UE to report the one or more channel correlation metrics is carried in message 3 (Msg3) of a random access channel (RACH) procedure or an uplink radio resource control (RRC) message.

4. The UE of claim 1, wherein the at least one processor is further operable to cause the UE to:
receive a signal that triggers the UE to report the one or more channel correlation metrics.

5. The UE of claim 4, wherein the signal that triggers the UE to report the one or more channel correlation metrics is carried in message 4 (Msg4) of a random access channel (RACH) procedure or downlink control information (DCI).

6. The UE of claim 1, wherein the at least one processor is further operable to cause the UE to:
receive a signal that schedules the UE to report the one or more channel correlation metrics.

7. The UE of claim 6, wherein the signal that schedules the UE to report the one or more channel correlation metrics is carried in a system information block (SIB) or downlink control information (DCI).

8. The UE of claim 1, wherein the signal indicating the one or more channel correlation metrics is carried in radio resource control (RRC)-configured uplink control information (UCI).

9. The UE of claim 1, wherein the at least one processor is further operable to cause the UE to:
receive a system information block (SIB) that indicates a quantity of bits to represent the one or more channel correlation metrics; and
compute a quantization of the one or more channel correlation metrics based at least in part on the SIB, wherein the signal indicating the one or more channel correlation metrics comprises the quantization of the one or more channel correlation metrics.

10. A network equipment (NE) for wireless communication, comprising:
at least one memory; and
at least one processor coupled with the at least one memory and operable to cause the NE to:
transmit a set of synchronization signals using a set of directional transmit beams; and
receive a signal indicating one or more channel correlation metrics that are based at least in part on the set of synchronization signals.

11. The NE of claim 10, wherein the at least one processor is further operable to cause the NE to:
receive a signal indicating a capability of a user equipment (UE) to report the one or more channel correlation metrics.

12. The NE of claim 11, wherein the signal indicating a capability of the UE to report the one or more channel correlation metrics is carried in message 3 (Msg3) of a random access channel (RACH) procedure or an uplink radio resource control (RRC) message.

13. The NE of claim 10, wherein the at least one processor is further operable to cause the NE to:
transmit a signal that triggers a user equipment (UE) to report the one or more channel correlation metrics.

14. The NE of claim 13, wherein the signal that triggers the UE to report the one or more channel correlation metrics is carried in message 4 (Msg4) of a random access channel (RACH) procedure or downlink control information (DCI).

15. The NE of claim 10, wherein the at least one processor is further operable to cause the NE to:
transmit a signal that schedules a user equipment (UE) to report the one or more channel correlation metrics.

16. The NE of claim 15, wherein the signal that schedules the UE to report the one or more channel correlation metrics is carried in a system information block (SIB) or downlink control information (DCI).

17. The NE of claim 10, wherein the signal indicating the one or more channel correlation metrics is carried in radio resource control (RRC)-configured uplink control information (UCI).

18. The NE of claim 10, wherein the at least one processor is further operable to cause the NE to:
transmit a system information block (SIB) that indicates a quantity of bits to represent the one or more channel correlation metrics, wherein the signal indicating the one or more channel correlation metrics comprises a quantization of the one or more channel correlation metrics that is based at least in part on the SIB.

19. A method performed by a user equipment (UE), the method comprising:
receiving a set of synchronization signals corresponding to a set of directional transmit beams;
computing one or more channel correlation metrics based at least in part on the set of synchronization signals; and
transmitting a signal indicating the one or more channel correlation metrics.

20. A method performed by a network equipment (NE), the method comprising:
transmitting a set of synchronization signals using a set of directional transmit beams; and receiving a signal indicating one or more channel correlation metrics that are based at least in part on the set of synchronization signals.
